(19) United States
(12) Patent Application Publication
(10) Pub. No.: US 2013/0092414 A1
(43) Pub. Date: Apr. 18, 2013

(54) CONNECTING STRUCTURE AND CONNECTING METHOD OF INSULATED WIRES

(71) Applicant: Naoki Ito, Makinohara-shi (JP)

(72) Inventor: Naoki Ito, Makinohara-shi (JP)

(73) Assignee: YAZAKI CORPORATION, Tokyo (JP)

(21) Appl. No.: 13/807,762

(22) PCT Filed: Jul. 5, 2011
(86) PCT No.: PCT/JP2011/065392

§ 371 Date: Dec. 31, 2012

(30) Foreign Application Priority Data
Jul. 5, 2010 (JP) 2010-153087

(51) Int. Cl. H01B 13/00; H01B 7/00

(52) U.S. Cl. CPC H01B 13/00; H01B 7/0009
USPC 174/113 R; 228/111

(57) ABSTRACT

A connecting structure includes a sheathing connecting section in which sheathed sections of a plurality of electric wires, which are sections at both sides of exposed conductor sections, are bundled together in a state of being superimposed with each other; and a conductor connecting section in which the conductor sections of the plurality of electric wires are intertwined in a state of being folded back, and a section of the folded back conductor section remaining as a result of excluding a portion of the folded back conductor section are ultrasonically bonded in integration.

### TECHNICAL FIELD

The invention relates to a connecting structure and a connecting method of insulated wires, wherein a plurality of insulated wires are intertwined and electrically connected in integration.

### BACKGROUND ART

When intertwining and electrically connecting insulated wires each having an insulated sheath, a variety of connecting methods have been adopted (for example, refer to Patent Documents 1 and 2). That is, the insulated sheaths of parts to be connected are stripped by a predetermined length, thereby exposing conductors. Then, the exposed conductors are soldered each other or are twisted together and connected by hand.

For example, as shown in FIG. 11, according to a connecting method disclosed in Patent Document 1, a rotary connector 100 that has an inlet 101, which has a cylindrical shape so as to have an enlargement, and two holes 102 having predetermined angles and a rotary shaft 103 is attached thereto is used to insert two cords into the holes and to rotate the rotary shaft. Thereby, the two cords are rotated at the same time, so that the two cords are intertwined and connected.

Also, as shown in FIG. 12, a connecting method disclosed in Patent Document 2 is a method of making an interlocking spiral twist connection between two wires 203, 204 and includes steps of positioning the wires 203, 204 in side by side relationship in cavity portions in both members 201, 202 and providing relative rotation between both members 201, 201 of a two-member connector. The cavity portions have such a configuration that the wires 203, 204 can be introduced into the cavity portions only in side by side relationship in the cavity portions when the wires are in a specific orientation relative to the cavity portions. The relative rotation of the two members 201, 202 causes the respective wires 203, 204 to be jammed against inner surfaces of the respective cavities. Also, a braking effect on the wires 203, 204 for controlling relative longitudinal movement between the wires under relative rotation and a converging force on the members 201, 202 are kept. Also, reference numerals 203A, 204A indicate accommodation parts in the connector.

Also, in recent years, an ultrasonic bonding has been adopted from a standpoint of a simple and secure operation. For example, according to a method shown in FIGS. 13(A) to 13(D), insulated sheaths of a plurality of insulated wires 301 to 304 are stripped to expose conductors 301A to 304A, which are then simply arranged in parallel (which also includes a parallel superimposed configuration). The exposed conductors arranged in parallel are subject to ultrasonic bonding, so that the conductors 301A to 304A are connected.

When the ultrasonic bonding is performed as described above, connection strength may be problematic in some cases. Specifically, a part of the conductors may be detached due to the insufficient connection strength.

Therefore, a connecting method of insulated wires as disclosed in Patent Document 3 has been suggested. That is, according to this connecting method of insulated wires, as shown in FIGS. 14(A), 14(B), 15(A) and 15(B), insulated sheaths of a plurality of insulated wires 401 to 404 are stripped by a predetermined length, respectively, thereby exposing conductors 401A to 404A. The exposed conductors 401A to 404A are twisted together in the same direction. Then, the twisted parts are welded and connected by ultrasonic bonding. Thereby, when electrically connecting the plurality of insulated wires 401 to 404, it is possible to secure the sufficient connection strength even though the conductors 401A to 404A are connected by the ultrasonic bonding.

### TECHNICAL DOCUMENTS

### Patent Documents

[Patent Document 1] JP-UM-A-6-88092

[Patent Document 2] JP-A-5-500288

[Patent Document 3] JP-A-2005-322544

### SUMMARY OF THE INVENTION

### Problems to be Solved by the Invention

However, according to the above connecting methods, for example, the method disclosed in Patent Document 1, when the cords are stiff or the number of cords is large, it is difficult to intertwine the cords. Also, according to the method of Patent Document 2, the connection is not made well with the intertwined wires. Also, it is necessary to prepare the connector in accordance with the number or diameters of the cords.

Also, according to the method disclosed in Patent Document 3, when intertwining the exposed conductors, it is necessary to hold the conductors with a jig and the like. Therefore, the conductors may be damaged, for example, may be scratched or disconnected at the conductor holder. Also, when the number of wires is large or when cross sections of the conductors are great, the damages to the conductors are increased due to the holder, so that the connection may not be made well.

The invention has been made to solve the above problems. An object of the invention is to provide a connecting structure and a connecting method of insulated wires, wherein damages to conductors are inhibited as much as possible when conductors of wires to be connected with each other are intertwined as a bundle, and damages to the conductors are minimized even when the number of wires to be connected is large or cross sections of the conductors are great.

### Means for Solving the Problems

In order to achieve the above object, a connecting structure of insulated wires of the invention is characterized by a following configuration (1).
(1) A connecting structure of insulated wires wherein conductor sections of a plurality of electric wires, which are exposed as sheaths of the electric wires are partially removed, are intertwined and ultrasonically bonded in integration, the connecting structure comprising:

a sheathing connecting section in which sheathed sections of the plurality of electric wires are bundled together in a state that both sheathed sections interposing the exposed conductor sections therebetween are superimposed with each other, and

a conductor connecting section in which the conductor sections of the respective electric wires are intertwined in a state that the exposed conductor sections are folded back and portions of the conductor sections except for portions of the folded back conductor sections are ultrasonically bonded in integration.

According to the connecting structure of insulated wires described in the above (1), it is possible to provide a connecting structure of insulated wires, wherein the damages to the conductors are inhibited as much as possible when the conductor sections of the respective electric wires to be connected with each other are intertwined as a bundle, and the damages to the conductors are minimized even though the number of wires to be connected is large or the cross sections of the conductors are great.

Also, a connecting method of insulated wires of the invention is characterized by following configurations (2) to (4).
(2) A connecting method of insulated wires, comprising the steps of:

removing a part of a sheath of each of a plurality of electric wires to expose a conductor section;

folding back the exposed conductor sections at a part and bundling sheathed sections of the respective electric wires in a state that both sheathed sections interposing the exposed conductor sections therebetween are superimposed with each other;

intertwining the folded back conductor sections of the respective electric wires; and

ultrasonically bonding portions of the conductor sections in integration, except for portions of the folded back conductor sections.
(3) In the connecting method of insulated wires described in the above (2), in the intertwining step of the conductor sections, a rotation jig is inserted into parts of the folded back conductor sections of the respective electric wires and is then rotated to intertwine the conductor sections.
(4) In the connecting method of insulated wires described in the above (2) or (3), the method further comprises a step of processing the intertwined conductor sections into a predetermined shape by using a forming jig, wherein in the ultrasonic bonding step, portions of the conductor sections processed into the predetermined shape are ultrasonically bonded in integration, except for portions of the folded back conductor sections.

According to the connecting method of insulated wires described in the above (2), it is possible to provide a connecting method of insulated wires, wherein the damages to the conductors are inhibited as much as possible when the conductor sections of the respective electric wires to be connected with each other are intertwined as a bundle, and the damages to the conductors are minimized even though the number of wires to be connected is large or the cross sections of the conductors are great.

According to the connecting method of insulated wires described in the above (3), it is possible to easily intertwine the conductors by the rotation jig. According to the connecting method of insulated wires described in the above (4), it is possible to effectively perform the ultrasonic bonding.

### Advantageous Effects of the Invention

According to the connecting structure of insulated wires of the invention, the damages to the conductors are inhibited as much as possible when the conductor sections of the respective electric wires to be connected with each other are intertwined as a bundle, and the damages to the conductors are minimized even though the number of wires to be connected is large or the cross sections of the conductors are great.

The invention has been briefly described. Also, the detailed configurations of the invention will be further clarified by reading through the illustrative embodiment that will be described below with reference to the accompanying drawings.

### BRIEF DESCRIPTION OF THE DRAWINGS

FIG. 1 is a perspective view showing a connecting structure of insulated wires to which a connecting method of insulted wires of an illustrative embodiment of the invention is applied.

FIGS. 2(A) and 2(B) show one wire that is used in the connecting structure of insulated wires according to the illustrative embodiment of the invention, wherein FIG. 2(A) shows the one wire that is used in the connecting structure of the insulated wires and FIG. 2(B) illustrates the one wire at a state that a sheath thereof is stripped.

FIGS. 3(A) and 3(B) show the other wire that is used in the connecting structure of insulated wires according to the illustrative embodiment of the invention, wherein FIG. 3(A) shows the other wire that is used in the connecting structure of the insulated wires and FIG. 3(B) illustrates the other wire at a state that a sheath thereof is stripped.

FIG. 4 shows one process of a connecting method of the connecting structure of the insulated wires.

FIG. 5 shows one process of a connecting method of the connecting structure of the insulated wires.

FIG. 6 shows one process of a connecting method of the connecting structure of the insulated wires.

FIG. 7 shows one process of a connecting method of the connecting structure of the insulated wires.

FIG. 8 shows one process of a connecting method of the connecting structure of the insulated wires.

FIG. 9 shows one process of a connecting method of the connecting structure of the insulated wires.

FIG. 10 shows an intertwining process that is performed using a separate rotation jig from a rotation jig shown in FIG. 4.

FIG. 11 is a sectional view showing a tool for electrically intertwining insulated wires according to a conventional technology.

FIG. 12 is a perspective view showing a method of intertwining cables by using another connecting tool according to a conventional technology.

FIGS. 13(A) to 13(D) illustrate a method of intertwining wires according to another conventional technology, wherein FIGS. 13(A) to 13(D) show one process of the method, respectively.

FIGS. 14(A) and 14(B) illustrate a method of intertwining wires according to another conventional technology, wherein FIGS. 14(A) and 14(B) are a front view and a side view showing a state before the intertwining.

FIGS. 15(A) and 15(B) show a state during the intertwining in the method of intertwining wires shown in FIGS. 14(A) and 14(B), wherein FIGS. 15(A) and 15(B) are a front view and a side view

### MODE FOR CARRYING OUT THE INVENTION

Hereinafter, illustrative embodiments of the invention will be described with reference to the accompanying drawings.

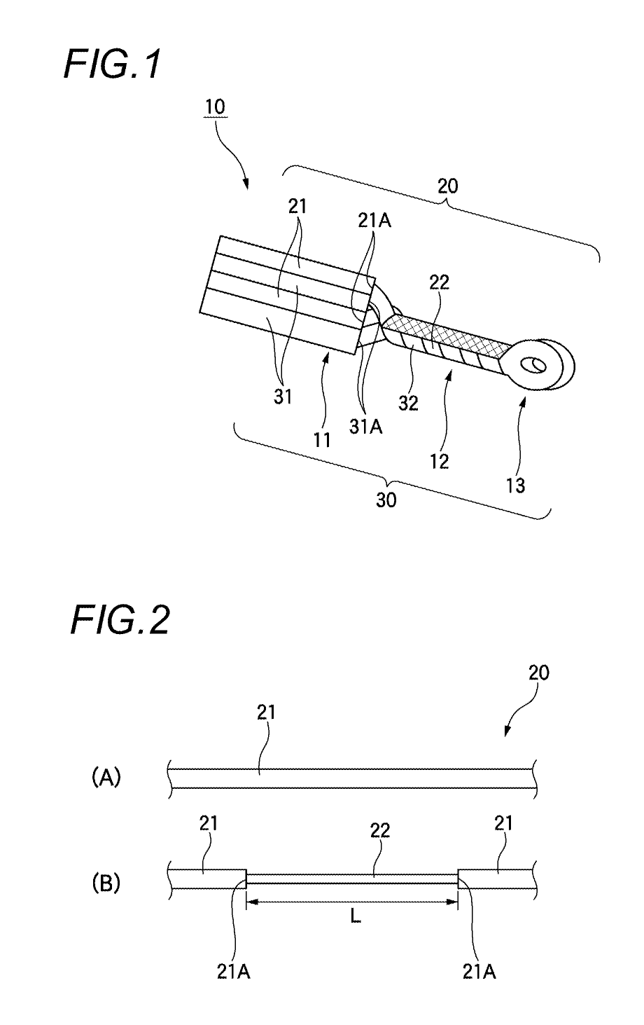

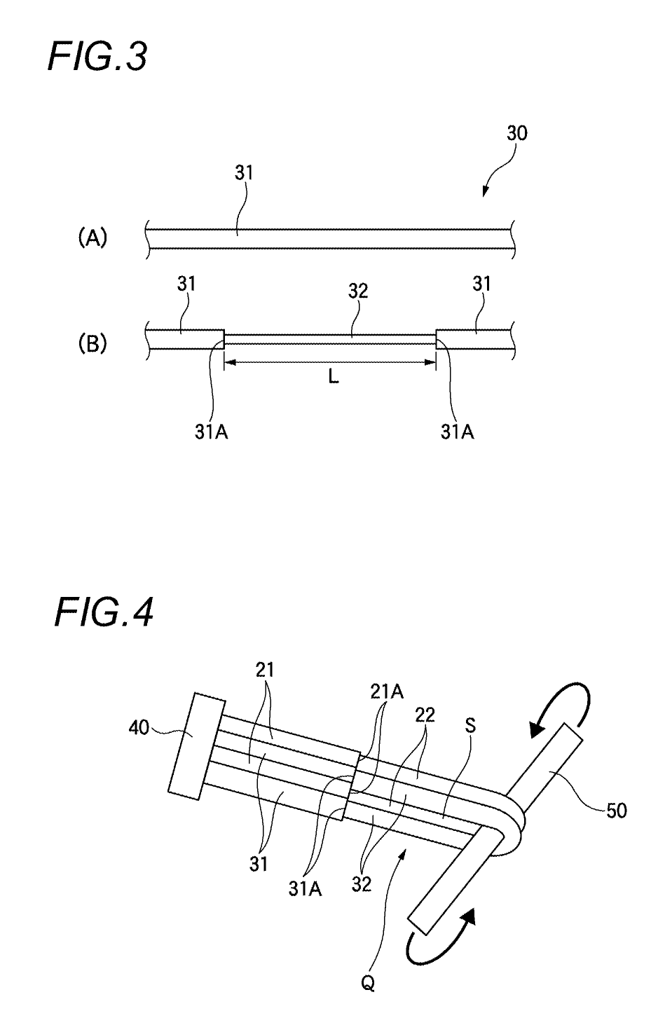

FIG. 1 shows a connecting structure 10 of insulated wires according to an illustrative embodiment of the invention. The connecting structure 10 of insulated wires has such a configuration that conductors 22, 32 (hereinafter, referred to as conductor sections. Refer to FIGS. 2(A), 2(B), 3(A) and 3(B)), which are exposed by stripping and removing sheaths positioned at central portions of a plurality of electric wires 20, 30 (two wires in this illustrative embodiment. However, the invention is not particularly limited to two wires) by a predetermined length, respectively, are intertwined and ultrasonically bonded in integration, and has a sheathing connecting section 11, a conductor connecting section 12 and a loop conductor section 13.

The sheathing connecting section 11 has such a configuration that respective sheathed sections 21, 31 of the plurality of electric wires 20, 30 are bundled together in a state that both sheathed sections 21 (31) of the sheath of the wire 20 (30) to be connected, which interpose the exposed conductor section 22 (32) between the sheathed sections 21, 31, are superimposed with each other.

The conductor connecting section 12 has such a configuration that the respective conductor sections 22, 32 are folded at folding points of the central portions thereof, the other wire 20 (30) is integrally intertwined with the folded back conductor section 22 (32) in a state that the exposed conductor sections 22, 32 are folded back, and portions of the conductor sections 22, 32 except for a portion (the loop conductor section 13 that will described later) of the folded back conductor sections 22, 32 are ultrasonically bonded in integration.

The loop conductor section 13 is configured by integrally forming a leading end of the conductor connecting section 12, which is formed by integrating the respective electric wires 20 (30), into a loop shape. Also, in this illustrative embodiment, the loop conductor section 13 remains. However, after the conductor connecting section 12 is formed, the loop conductor section 13 may be cut off because the conductor connecting section 12 is not unfastened.

In the below, a method of forming the connecting structure 10 of insulated wires according to this illustrative embodiment is described with reference to FIGS. 2(A) to 9.

First, the plurality of electric wires 20, 30 to be intertwined (two wires, in this illustrative embodiment) is prepared (refer to FIGS. 2(A) and 3(A)), the respective sheaths of the electric wires 20, 30 are stripped and removed by a predetermined length L, thereby exposing the conductor sections 22, 32 by the predetermined length L (refer to FIGS. 2(B) and 3(B)). Also, both edge portions of both sheathed sections 21, 31 of the respective electric wires, which interpose the conductor sections 22, 32 therebetween, are referred to as ‘conductor-boundary edge portions 21A (31A).’

Then, the respective electric wires 20, 30 are folded back into two by using, as a reference point, a central portion L/2 of the respective conductor sections 22, 32 exposed by the predetermined length L as described above. Thereby, the conductor sections 22, 32 of the respective electric wires 20, 30 are formed into a loop shape (refer to FIG. 4). The ‘loop shape’ means that a gap is suppressed to the minimum, i.e., a slit-shaped opening S (refer to FIG. 4) is provided.

As shown in FIG. 4, the sheathed sections 21, 31 of the respective bent electric wires 20, 30 are fixed and held in integration as a bundle by a holding jig 40. A penetration member 50 of a rotation jig is enabled to pass through the opening S of a folded section Q of the conductor sections 22, 32 of the respective electric wires 20, 30, the folded section is formed by folding back the conductor sections into the loop shape.

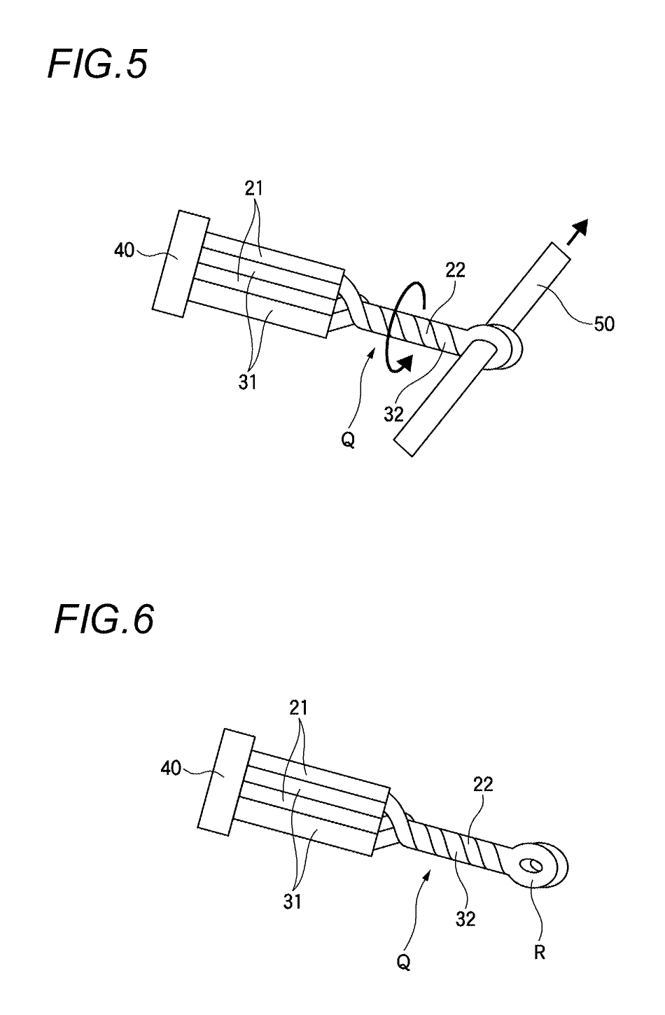

Then, as shown in FIG. 4, the penetration member 50 is rotated by the rotation jig to thus twist the folded section Q of the conductor sections 22, 32 of the electric wires 20, 30 several times. Thereby, as shown in FIG. 5, the folded section Q, which is the conductor sections 22, 32 of both electric wires 20, 30, is intertwined in integration. By the rotation jig, it is possible to easily intertwine the conductor sections 22, 32.

By doing so, the folded section Q, which is the conductor sections 22, 32 of both electric wires 20, 30, is twisted and intertwined in integration, so that all areas except for a section leaving the penetration member 50 are intertwined. As a result, the opening S of the folded section Q is pushed to the leading end, so that the opening S is narrowed and the penetration member 50 of the rotation jig is pulled out from the opening S, thereby forming a ring section R (refer to FIG. 6).

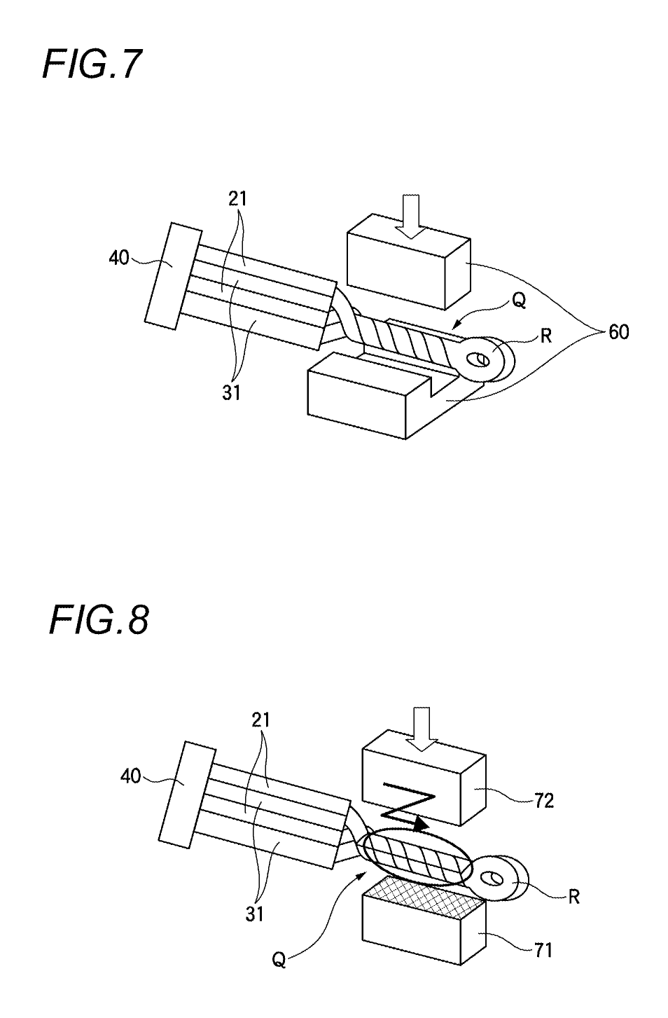

Then, as shown in FIG. 7, the folded section Q, which is the conductor sections 22, 32 of both electric wires 20, 30, is pressurized into a predetermined shape by a pair of upper and lower forming jigs 60. This processing is not necessarily required. However, by the processing, it is possible to efficiently perform the ultrasonic bonding that will be described below.

As shown in FIG. 8, the intertwined folded section Q as described above is pressed (refer to a white arrow in FIG. 8), vibrated (refer to a solid arrow in FIG. 8) and is thus ultrasonically bonded by using an anvil 71 and a horn 72. Thereby, the conductor connecting section 12 is formed in which the conductor sections 22, 32 of the pair of wires are completely bonded in integration from the folded section Q.

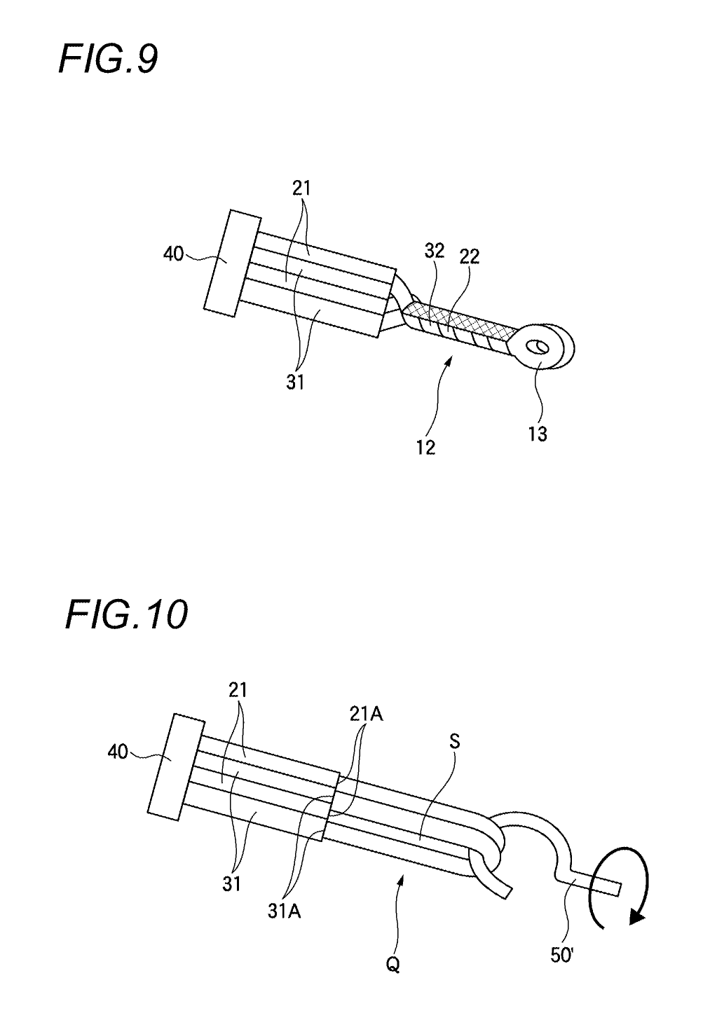

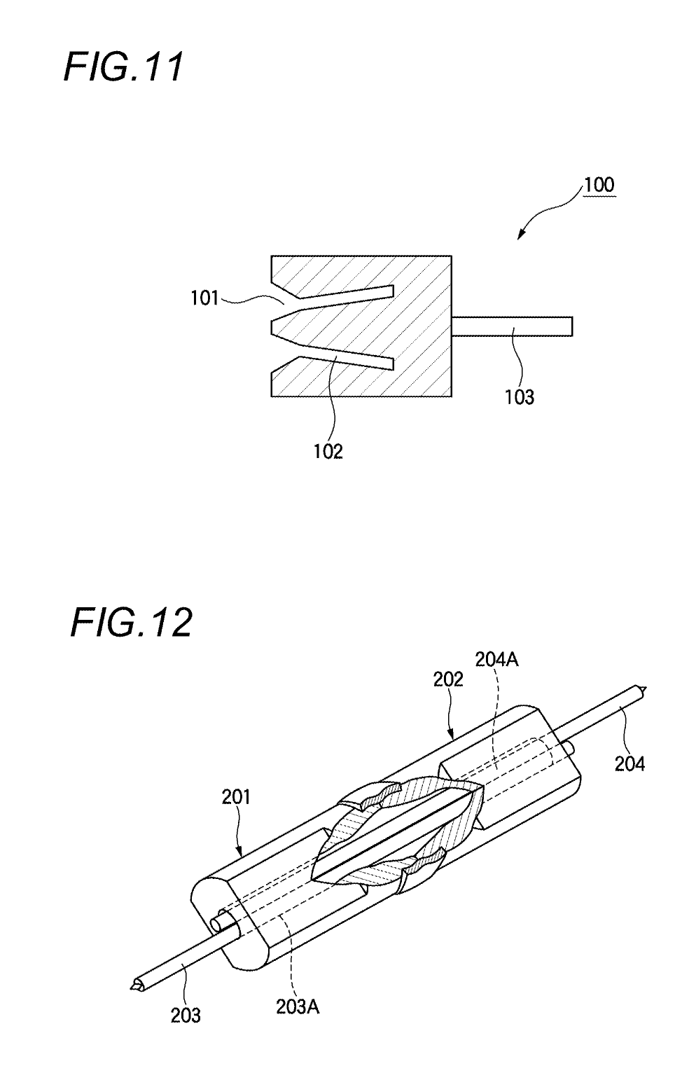

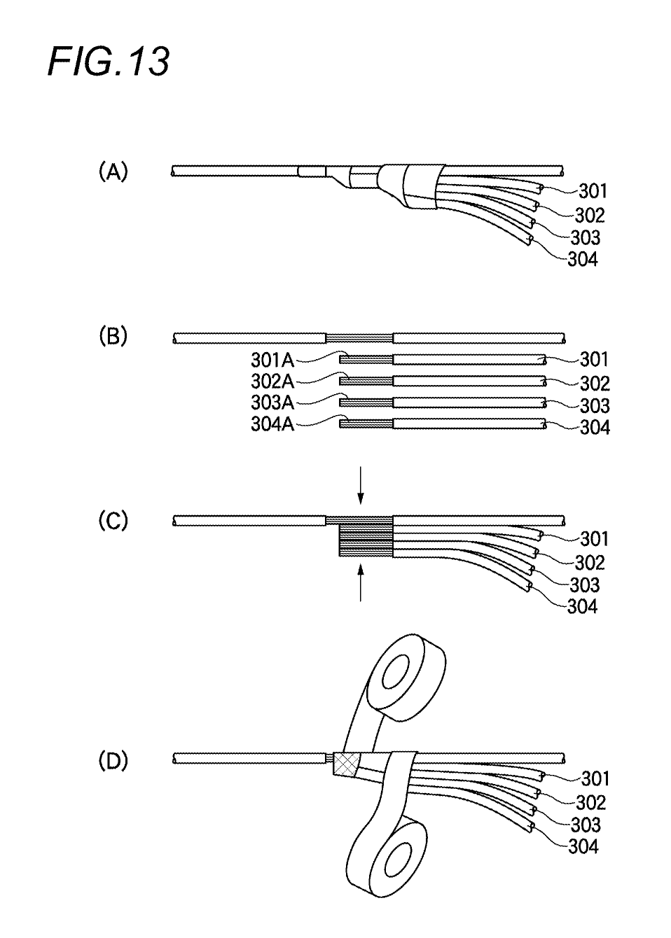

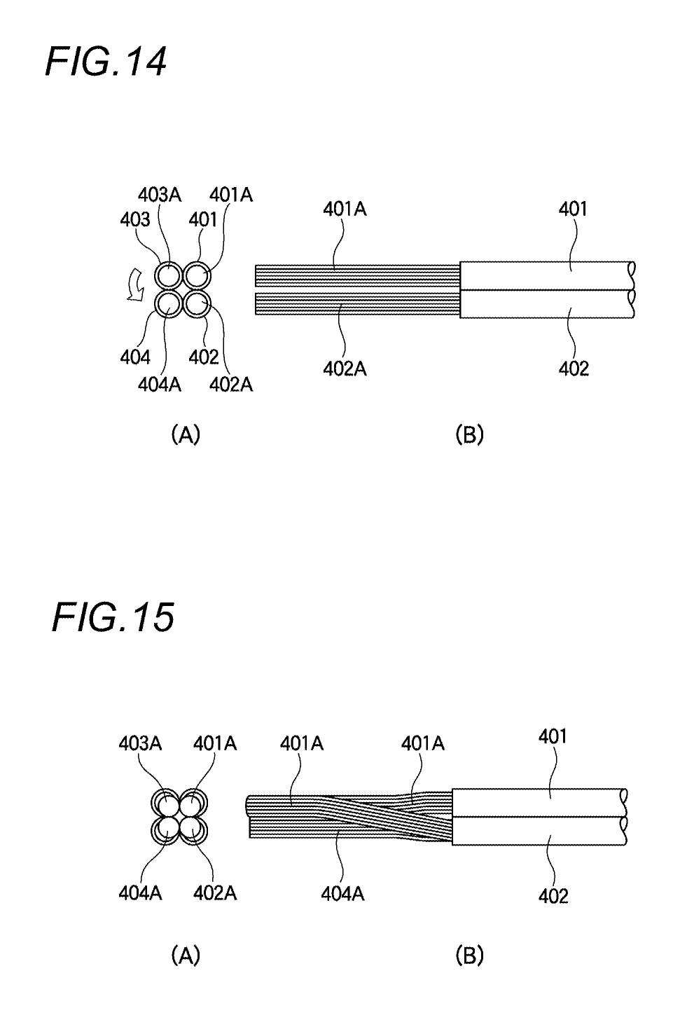

Also, when the ring section R is left until the ultrasonic bonding is performed, i.e., after the conductor connecting section 12 is formed from the folded section Q by the ultrasonic bonding, the conductor sections 22, 32 are not naturally unfastened. Therefore, the ring section may be cut out. However, in this illustrative embodiment, the ring section remains as the loop conductor section 13, as shown in FIG. 9.

Also, after the connector connecting section 12 is formed by the ultrasonic bonding operation as described above, the conductor-boundary edges 21A (31A) of the sheathed sections 21, 31 of the respective electric wires 20, 30 are not naturally unfastened. Accordingly, it is possible to finally remove the holding jig 40 that incorporates the adjacency of the conductor-boundary edges 21A (31A) and integrally fixes and holds the same.

Also, in this illustrative embodiment, the folded section Q, which is the conductor sections 22, 32 of the respective electric wires 20, 30, is integrally twisted and intertwined to thus form the conductor connecting section 12 by using the holding jig 40 and the penetration member 50 of the rotation jig. However, as shown in FIG. 10, the folded section Q may be integrally twisted and intertwined by using a rotation jig 50′ together with the holding jig 40.

Therefore, according to the method of forming the connecting structure 10 of insulated wires of this illustrative embodiment, the conductor sections are held by the holding jig. Hence, the conductor damages that are caused when the conductor sections 22, 32 are held are remarkably decreased. Thus, when forming the connecting structure 10 of the invention by the intertwining, it is possible to apply the connecting structure and method of the invention even though the number of the electric wires is large or the cross sections of the conductors are great.

Also, the invention is not limited to the above illustrative embodiment and can be implemented in various aspects without departing from the gist of the invention.

Although the invention has been specifically described with reference to the specific illustrative embodiments, a variety of changes and modifications can be made without departing from the spirit and scope of the invention.

This application is based on Japanese Patent Application No. 2010-153087 filed on Jul. 5, 2010, the disclosures of which are incorporated herein by reference.

### INDUSTRIAL APPLICABILITY

According to the connecting structure of insulated wires of the invention, the damages to the conductors are inhibited as much as possible when the conductor sections of the respective electric wires to be connected with each other are intertwined as a bundle, and the damages to the conductors are minimized even though the number of wires to be connected is large or the cross sections of the conductors are great.

### DESCRIPTION OF REFERENCE NUMERALS AND SIGNS

10: connecting structure of insulated wires

11: sheathing connecting section

12: conductor connecting section

13: loop conductor section

20, 30: wire

21, 31: sheathed section

21A, 31A: conductor-boundary edge portion

22, 32: conductor section

40: holding jig

50: penetration member of rotation jig

50′: rotation jig

60: forming jig

71: anvil

72: horn

Q: folded section

R: ring section

S: opening

1. A connecting structure of insulated wires wherein conductor sections of a plurality of electric wires, which are exposed as sheaths of the electric wires are partially removed, are intertwined and ultrasonically bonded in integration, the connecting structure comprising:
a sheathing connecting section in which sheathed sections of the plurality of electric wires are bundled together in a state that both sheathed sections interposing the exposed conductor sections therebetween are superimposed with each other, and
a conductor connecting section in which the conductor sections of the respective electric wires are intertwined in a state that the exposed conductor sections are folded back and portions of the conductor sections except for portions of the folded back conductor sections are ultrasonically bonded in integration.

2. A connecting method of insulated wires, comprising the steps of:
removing a part of a sheath of each of a plurality of electric wires to expose a conductor section;
folding back the exposed conductor sections at a part and bundling sheathed sections of the respective electric wires in a state that both sheathed sections interposing the exposed conductor sections therebetween are superimposed with each other;
intertwining the folded back conductor sections of the respective electric wires; and
ultrasonically bonding portions of the conductor sections in integration, except for portions of the folded back conductor sections.

3. The connecting method of insulated wires according to claim 2, wherein in the intertwining step of the conductor sections, a rotation jig is inserted into parts of the folded back conductor sections of the respective electric wires and is then rotated to intertwine the conductor sections.

4. The connecting method of insulated wires according to claim 2, further comprising:
a step of processing the intertwined conductor sections into a predetermined shape by using a forming jig,
wherein in the ultrasonic bonding step, portions of the conductor sections processed into the predetermined shape are ultrasonically bonded in integration, except for portions of the folded back conductor sections.
